(19) United States
(12) Patent Application Publication
(10) Pub. No.: US 2023/0356519 A1
(43) Pub. Date: Nov. 9, 2023

(54) APPARATUS FOR PRODUCING GLASS LAMINATION ARTICLES AND METHOD FOR PRODUCING GLASS LAMINATION ARTICLES USING THE SAME

(71) Applicant: CORNING INCORPORATED, CORNING, NY (US)

(72) Inventors: Jong-chul Kim, Cheonan-si (KR); Bum Gook Lee, Seoul (KR); Hyeon-gug Seo, Cheonan-si (KR)

(21) Appl. No.: 18/017,508

(22) PCT Filed: Jul. 19, 2021
(86) PCT No.: PCT/US2021/042133

§ 371 Date: Jan. 23, 2023

(30) Foreign Application Priority Data
Jul. 30, 2020 (KR) 10-2020-0095576

(51) Int. Cl. B32B 38/18; B32B 7/12; B32B 17/06; B32B 37/12; B32B 37/20; B65G 49/06

(52) U.S. Cl. CPC B32B 38/1833; B32B 7/12; B32B 17/06; B32B 37/12; B32B 37/20; B65G 49/065; B32B 2309/10; B32B 2315/08; B32B 2250/02

(57) ABSTRACT

An apparatus including: a base supply unit including convey rollers configured to transfer a base, and centering bars each arranged between two adjacent ones of the convey rollers, the centering bars being configured to have an adjustable height; a glass supply unit arranged at a vertical level higher than the base supply unit and configured to transfer a glass substrate layer; and a laminate unit including a laminating roller configured to laminate the glass substrate layer on the base with an adhesive layer therebetween. In addition, there is provided a method of producing glass lamination articles using the apparatus.

### CROSS-REFERENCE TO RELATED APPLICATION

This application claims the benefit of priority under 35 U.S.C. § 371 of International Application No. PCT/US2021/042133, filed on Jul. 19, 2021 which claims the benefit of Korean Patent Application No. 10-2020-0095576, filed on Jul. 30, 2020, in the Korean Intellectual Property Office, the disclosure of each of which is incorporated herein in its entirety by reference.

### BACKGROUND

### 1. Field

One or more embodiments relate to an apparatus for producing glass lamination articles and a method of producing glass lamination articles using the apparatus, and more particularly, to an apparatus for producing glass lamination articles through a bonding process and a method of producing glass lamination articles using the apparatus.

### 2. Description of Related Art

Glass lamination articles, which include a base and a glass substrate layer attached to the base, are used in various applications such as automotive components, electronic components, and structural components of buildings. In general, glass lamination articles have a relatively small thickness, and a transparent adhesive film or ultraviolet irradiation is widely used to bond the base and the glass substrate layer to each other. However, when the transparent adhesive film is used, surface waviness may be present after bonding. In addition, when an ultraviolet irradiation method is used to form a large-area glass lamination article, a slip or positional deviation may occur between the base and the glass substrate layer of the glass lamination article, and thus aesthetic incompleteness such as bubbles may be formed in the glass lamination article.

### SUMMARY

One or more embodiments include an apparatus for producing glass lamination articles through a bonding process in which the positions of a base and a glass substrate layer are precisely adjusted.

One or more embodiments include a method of producing glass lamination articles through a bonding process in which the positions of a base and a glass substrate layer are precisely adjusted.

Additional aspects will be set forth in part in the description which follows and, in part, will be apparent from the description, or may be learned by practice of the presented embodiments of the disclosure.

According to one or more embodiments, an apparatus for producing glass lamination articles includes: a base supply unit including a plurality of convey rollers configured to transfer a base, and a plurality of centering bars each arranged between two adjacent ones of the plurality of convey rollers, the plurality of centering bars being configured to have an adjustable height; a glass supply unit arranged at a vertical level higher than the base supply unit and configured to transfer a glass substrate layer; and a laminate unit including a laminating roller configured to laminate the glass substrate layer on the base with an adhesive layer therebetween.

In example embodiments, each of the plurality of centering bars may be arranged between two adjacent ones of the plurality of convey rollers such that the base is aligned with a target position by each of the plurality of centering bars while the base is transferred by the plurality of convey rollers.

In example embodiments, the plurality of centering bars may be configured such that when operating in a position adjustment mode, at least one of the plurality of centering bars may move upward to a vertical level higher than uppermost surfaces of the plurality of convey rollers to make contact with a bottom surface of the base, and when operating in a transfer mode, the plurality of centering bars may move downward to a vertical level lower than the uppermost surfaces of the plurality of convey rollers to depart from the bottom surface of the base and allow the uppermost surfaces of the plurality of convey rollers to make contact with the bottom surface of the base.

In example embodiments, the plurality of convey rollers may extend each in a first direction and may be apart from each other in a second direction perpendicular to the first direction, the plurality of centering bars may extend each in the first direction and may be apart from each other in the second direction perpendicular to the first direction, and the plurality of centering bars and the plurality of convey rollers may be alternately arranged in the second direction.

In example embodiments, the plurality of convey rollers may extend each in a first direction and may be apart from each other in a second direction perpendicular to the first direction, the plurality of centering bars may extend each in the first direction and may be apart from each other in the second direction perpendicular to the first direction, and the plurality of convey rollers and the plurality of centering bars may be arranged in such a manner that two convey rollers and one centering bar may be sequentially and repeatedly arranged in the second direction.

In example embodiments, the plurality of convey rollers may include a plurality of first edge convey rollers, a plurality of central convey rollers, and at least one second edge convey roller, and the at least one second edge convey roller may be adjacent to the laminate unit, wherein each of the plurality of centering bars may be arranged between two adjacent ones of the plurality of central convey rollers.

In example embodiments, the plurality of convey rollers may include a plurality of first edge convey rollers, a plurality of central convey rollers, and a plurality of second edge convey rollers, and the plurality of second edge convey rollers may be adjacent to the laminate unit, wherein the plurality of centering bars may be respectively arranged between two adjacent ones of the plurality of first edge convey rollers and between two adjacent ones of the plurality of second edge convey rollers.

In example embodiments, each of the plurality of centering bars may include: a base bar extending in a first direction and including a plurality of openings; and convey balls arranged on the base bar in such a manner that lower portions of the convey balls may be placed in the plurality of openings of the base bar, and upper portions of the convey balls may be placed outside the plurality of openings of the base bar.

In example embodiments, the plurality of convey rollers may have a width of about 500 mm to about 2000 mm, and a distance between the plurality of covey rollers may be from about 30 mm to about 300 mm.

In example embodiments, the plurality of convey rollers may be polymeric rollers, for example, may include polyurethane resin, and the plurality of convey rollers may be connected to and driven by a timing belt.

In example embodiments, the glass supply unit may include: a glass feeding part arranged adjacent to the laminate unit at a vertical level higher than the plurality of convey rollers of the base supply unit; and a gripper configured to fix an edge of the glass substrate layer for feeding the glass substrate layer into the laminate unit by using the glass feeding part.

In example embodiments, the plurality of convey rollers, the laminating roller, and the glass feeding part may be configured to be synchronized with each other and driven by a servo motor.

In example embodiments, the gripper may be configured such that while the glass substrate layer is moved a predetermined distance toward the laminate unit after the glass substrate layer is fed into the laminate unit, the gripper may hold the glass substrate layer and may move together with the glass substrate layer toward the laminate unit in a moving direction of the glass substrate layer, and when the gripper arrives at a stop position, the gripper may release the glass substrate layer, wherein the stop position may be apart from the laminate unit.

In example embodiments, the glass feeding part may include a plurality of through-holes and may be configured such that a bottom surface of the glass substrate layer may be arranged on a top surface of the glass feeding part, and the glass supply unit may further include a gas spraying device configured to spray gas onto the bottom surface of the glass substrate layer through the plurality of through-holes.

In example embodiments, the glass supply unit may further include a guide member arranged on the glass feeding part and configured to stop the glass substrate layer by making contact with an edge of the glass substrate layer.

In example embodiments, the laminating roller of the laminate unit may include a first roller and a second roller, wherein the first and second rollers may be arranged such that a bottom surface of the base may come into contact with the first roller, and a top surface of the glass substrate layer may come into contact with the second roller, and while the base and the glass substrate layer pass between the first and second rollers, the base and the glass substrate layer may be attached to each other through the adhesive layer between the base and the glass substrate layer.

In example embodiments, the laminating roller of the laminate unit may further include a third roller arranged at a vertical level higher than the second roller and configured to make contact with the second roller and rotate in a direction opposite to a rotation direction of the second roller.

In example embodiments, the apparatus may further include an absorptive member supply unit configured to pass an absorptive member between the first and second rollers such that the absorptive member is between the second roller and the glass substrate layer.

In example embodiments, the absorptive member may be configured to absorb a portion of a material of the adhesive layer which leaks between edges of the base and the glass substrate layer when the base and the glass substrate layer pass through a gap between the first and second rollers and may be attached to each other.

According to one or more embodiments, an apparatus for producing glass lamination articles includes: a base supply unit including a plurality of convey rollers extending in a first direction and a plurality of centering bars each arranged between two adjacent ones of the plurality of convey rollers, the base supply unit being configured to transfer a base; a glass supply unit including a glass feeding part and a gripper configured to grip a glass substrate layer and move the glass substrate layer on the glass feeding part; and a laminate unit including a laminating roller configured to laminate the base and the glass substrate layer together, wherein each of the plurality of centering bars include: a base bar extending in the first direction and including a plurality of openings; and convey balls arranged in the plurality of openings of the base bar and protruding upward from a top surface of the base bar.

In example embodiments, the plurality of centering bars may be adjustable in height with respect to the plurality of convey rollers, and each of the plurality of centering bars may be arranged between two adjacent ones of the plurality of convey rollers such that the base is aligned with a target position by each of the plurality of centering bars while the base is transferred on the plurality of convey rollers.

In example embodiments, the plurality of centering bars may be configured such that when operating in a position adjustment mode, at least one of the plurality of centering bars may move upward to a vertical level higher than uppermost surfaces of the plurality of convey rollers to make contact with a bottom surface of the base, and when operating in a transfer mode, the plurality of centering bars may move downward to a vertical level lower than the uppermost surfaces of the plurality of convey rollers to depart from the bottom surface of the base and allow the uppermost surfaces of the plurality of convey rollers to make contact with the bottom surface of the base.

In example embodiments, the glass feeding part may include a plurality of through-holes and may be configured such that a bottom surface of the glass substrate layer may be arranged on a top surface of the glass feeding part, and the glass supply unit may further include a gas spraying device configured to spray gas onto the bottom surface of the glass substrate layer through the plurality of through-holes.

In example embodiments, the glass supply unit may further include a guide member arranged on the glass feeding part unit and configured to stop the glass substrate layer by making contact with an edge of the glass substrate layer.

In example embodiments, the gripper may be configured such that while the glass substrate layer is moved a predetermined distance toward the laminate unit after the glass substrate layer is fed into the laminate unit, the gripper may hold the glass substrate layer and may move together with the glass substrate layer toward the laminate unit in a moving direction of the glass substrate layer, and when the gripper arrives at a stop position, the gripper may release the glass substrate layer, wherein the stop position may be apart from the laminate unit.

In example embodiments, the laminating roller of the laminate unit may include a first roller, a second roller, and a third roller, wherein: the first and second rollers may be arranged such that a bottom surface of the base may come into contact with the first roller, and a top surface of the glass substrate layer may come into contact with the second roller; while the base and the glass substrate layer pass between the first and second rollers, the base and the glass substrate layer may be attached to each other through an adhesive layer between the base and the glass substrate layer; and the third roller may be arranged at a vertical level higher than the second roller and configured to make contact with the second roller and rotate in a direction opposite to a rotation direction of the second roller.

According to one or more embodiments, a method of producing glass lamination articles includes: transferring a base using a base supply unit, the base supply unit including a plurality of convey rollers extending in a first direction and a plurality of centering bars each arranged between two adjacent ones of the plurality of convey rollers in a height adjustable manner; transferring a glass substrate layer using a glass supply unit, the glass supply unit including a glass feeding part and a gripper; feeding the base and the glass substrate layer into a laminate unit, the laminate unit including a first roller and a second roller; and forming a glass lamination article by passing the base and the glass substrate layer between the first and second rollers to attach the glass substrate layer to the base.

In example embodiments, the transferring of the base may include: transferring the base in a second direction perpendicular to the first direction by using the plurality of convey rollers; and adjusting a position of the base in the first direction by using the plurality of centering bars.

In example embodiments, in the transferring of the base, top surfaces of the plurality of centering bars may be placed lower than top surfaces of the plurality of convey rollers, and a bottom surface of the base may not be in contact with the top surfaces of the plurality of centering bars, and in the adjusting of the position of the base, the top surfaces of the plurality of centering bars may be placed higher than the top surfaces of the plurality of convey rollers, and the bottom surface of the base may come into contact with the top surfaces of the plurality of centering bars.

In example embodiments, each of the plurality of centering bars may include: a base bar extending in the first direction and including a plurality of openings; and convey balls arranged in the plurality of openings of the base bar and protruding upward from a top surface of the base bar.

In example embodiments, the glass feeding part may include a plurality of through-holes, and the glass supply unit further may include a gas spraying device arranged below the glass feeding part, wherein the transferring of the glass substrate layer may include: spraying gas onto a bottom surface of the glass substrate layer placed on the glass feeding part by using the gas spraying device; and moving the glass substrate layer toward the laminate unit while holding an edge of the glass substrate layer with the gripper.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view illustrating a glass lamination article producing apparatus according to example embodiments;

FIG. 2 is a perspective view schematically illustrating a base supply unit according to example embodiments;

FIG. 3 is a top view schematically illustrating the base supply unit shown in FIG. 2;

FIG. 4 is a front view schematically illustrating the base supply unit in a transfer mode;

FIG. 5 is a top view schematically illustrating the base supply unit in a position adjustment mode;

FIG. 6 is a front view schematically illustrating the base supply unit in the position adjustment mode;

FIG. 7 is a top view schematically illustrating the base supply unit in the position adjustment mode according to other embodiments;

FIG. 8 is a perspective view schematically illustrating a glass supply unit according to example embodiments;

FIG. 9 is a cross-sectional view taken along line IX-IX′ of FIG. 8;

FIG. 10 is a perspective view schematically illustrating a glass supply unit according to example embodiments;

FIG. 11 is a cross-sectional view schematically illustrating a glass lamination article according to example embodiments;

FIG. 12 is a top view schematically illustrating a base supply unit according to example embodiments;

FIG. 13 is a top view schematically illustrating a base supply unit according to example embodiments;

FIG. 14 is a top view schematically illustrating a base supply unit according to example embodiments;

FIG. 15 is a schematic view illustrating an apparatus for producing glass lamination articles according to example embodiments;

FIG. 16 is a schematic view illustrating an apparatus for producing glass lamination articles according to example embodiments; and

FIG. 17 is a flowchart illustrating a method of producing glass lamination articles according to example embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments will now be described with reference to the accompanying drawings. However, the embodiments may have different forms and should not be construed as being limited to the descriptions set forth herein. The embodiments are provided so that this disclosure will be thorough and complete, and will fully convey the scope of the present disclosure to those skilled in the art. In the drawings, like reference numbers refer to like elements throughout. In addition, elements and regions are schematically illustrated in the accompanying drawings. Therefore, the idea of the present disclosure is not limited to the relative sizes or distances shown in the accompanying drawings.

Although terms such as “first” and “second” may be used herein to describe various elements, these elements should not be limited by these terms. These terms are only used to distinguish one element from other elements. For example, a first element may be termed a second element, or a second element may be termed a first element without departing from the teachings of the present disclosure.

In the following description, technical terms are used only for explaining specific embodiments, and are not purposes of limitation. The terms of a singular form may include plural forms unless otherwise mentioned. The meaning of “include” or “comprise” specifies a property, a fixed number, a step, a process, an element, a component, and a combination thereof but does not exclude other properties, fixed numbers, steps, processes, elements, components, and combinations thereof.

Unless otherwise defined, all terms (including technical and scientific terms) used herein have the same meaning as commonly understood by those of ordinary skill in the art to which the inventive concept belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The order of processes explained in one embodiment may be changed in a modification of the embodiment or another embodiment. For example, two processes sequentially explained may be performed substantially at the same time or in the reverse of the explained order.

Shapes illustrated in the drawings may be varied according to various factors such as manufacturing methods and/or tolerances. That is, the embodiments of the inventive concept are not limited to particular shapes illustrated in the drawings. Factors such as shape changes in manufacturing processes should be considered. All terms used herein “and/or” elements described herein may be included individually or in combination within the scope of the present disclosure. In addition, the term “substrate” used herein may refer to a substrate itself or a laminate structure including a substrate and a layer or film formed on the substrate. In addition, the expression “a surface of a substrate” may refer to an exposed surface of a substrate itself, or an outer surface of a layer, a film, or the like formed on the substrate.

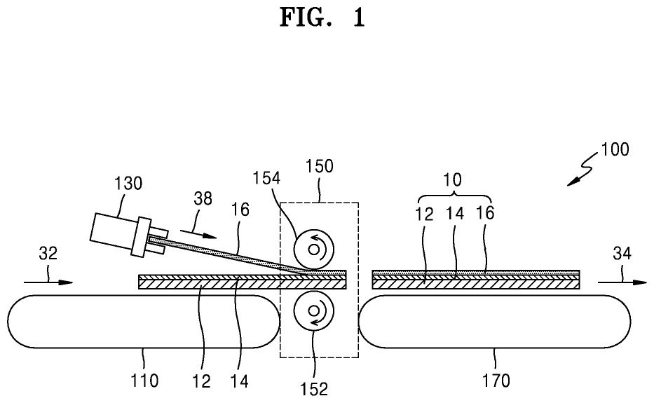

FIG. 1 is a schematic view illustrating a glass lamination article producing apparatus 100 according to example embodiments.

Referring to FIG. 1, the glass lamination article producing apparatus 100 may be an apparatus for producing a glass lamination article 10 by bonding a base 12 and a glass substrate layer 16 together. The glass lamination article producing apparatus 100 may include a base supply unit 110, a glass supply unit 130, a laminate unit 150, and a discharge unit 170.

The base supply unit 110 may be configured to transfer the base 12 to the laminate unit 150. The base supply unit 110 may be connected between an adhesive-layer application unit (not shown) and the laminate unit 150 to transfer the base 12 from the adhesive-layer application unit to the laminate unit 150. For example, the adhesive-layer application unit may apply an adhesive layer 14 on the base 12 to a predetermined thickness, and the base 12 on which the adhesive layer 14 is formed may be moved from the adhesive-layer application unit to the laminate unit 150 by the base supply unit 110.

In addition, the base 12 may be additionally processed by an additional processing device (not shown) before the base 12 passes through the adhesive-layer application unit. For example, the additional processing device may include a cutting device configured to cut the base 12, a scoring device configured to score edges of the base 12, a washing device configured to wash the surface of the base 12, a drying device configured to dry the surface of the base 12, or the like.

The base supply unit 110 may be configured to transfer the base 12 to the laminate unit 150 in a base transfer direction 32, and while a portion of the base 12 passes through the laminate unit 150, the remaining portion of the base 12 may be transferred on the base supply unit 110 toward the laminate unit 150 at a predetermined speed in the base transfer direction 32.

The glass supply unit 130 may be configured to feed the glass substrate layer 16 into the laminate unit 150. In example embodiments, the gass supply unit 130 may convey the glass substrate layer 16 which has a form of a glass sheet, and feed the glass sheet into the laminate unit 150. The glass supply unit 130 may operate to feed the glass substrate layer 16 (for example, having a form of a glass sheet) into the laminate unit 150 in a glass substrate layer transfer direction 38.

In example embodiments, the glass substrate layer transfer direction 38 may be inclined by a predetermined inclination angle from the base transfer direction 32. For example, the glass substrate layer transfer direction 38 may be inclined from the base transfer direction 32 by an angle of about 5 degrees to about 30 degrees, about 5 degrees to about 10 degrees, about 5 degrees to about 15 degrees, about 10 degrees to about 30 degrees, about 10 degrees to about 40 degrees, about 15 degrees to about 25 degrees, or about 15 degrees to about 30 degrees. However, an inclination angle of the glass substrate layer transfer direction 38 is not limited thereto.

In example embodiments, the glass supply unit 130 may be configured such that the glass substrate layer 16 may be fed toward the laminate unit 150 at a vertical level higher than the base supply unit 110 and may thus be placed at a vertical level higher than the base 12 at a position adjacent to the laminate unit 150.

In example embodiments, the glass supply unit 130 may transfer the glass substrate layer 16 to the laminate unit 150 in the glass substrate layer transfer direction 38, and while a portion of the glass substrate layer 16 passes through the laminate unit 150, the glass supply unit 130 may transfer the remaining portion of the glass substrate layer 16 toward the laminate unit 150 at a predetermined speed in the glass substrate layer transfer direction 38.

The laminate unit 150 may include a laminating roller, and the laminating roller may include a first roller 152 and a second roller 154. The first roller 152 and the second roller 154 may be spaced a predetermined distance from each other such that a portion of the base 12 and a portion of the glass substrate layer 16 that pass between the first roller 152 and the second roller 154 may be bonded together by the adhesive layer 14 placed therebetween. Therefore, a portion of the glass substrate layer 16 and a portion of the base 12 are apart from each other before passing through a space between the first roller 152 and the second roller 154, and the portion of the glass substrate layer 16 and the portion of the base 12 are bonded together while passing between the first roller 152 and the second roller 154. In addition, while the first roller 152 rotates clockwise as shown in FIG. 1 to pass the base 12 in the base transfer direction 32, the second roller 154 may rotate counterclockwise as shown in FIG. 1 such that the glass substrate layer 16 fed to the second roller 154 in the glass substrate layer transfer direction 38 may be bonded to the base 12 by the second roller 154.

Although not shown in FIG. 1, both ends of the first roller 152 and both ends of the second roller 154 may be fixed to a support structure (not shown), and the distance between the first roller 152 and the first roller 152 may be constantly maintained by the support structure.

In example embodiments, the laminate unit 150 may further include an ultraviolet irradiation device (not shown) in addition to the laminating roller. When bonded parts including the base 12, the adhesive layer 14, and the glass substrate layer 16 pass through the ultraviolet irradiation unit, the adhesive layer 14 may be cured, and thus a glass lamination article 10 including the base 12, the adhesive layer 14, and the glass substrate layer 16 may be formed.

The discharge unit 170 may be configured to transfer the glass lamination article 10 from the laminate unit 150 towards a subsequent processing unit (not shown). The discharge unit 170 may be configured to transfer the glass lamination article 10 in a discharge direction 34, and the transfer speed of the discharge unit 170 may be substantially the same as the transfer speed of the base 12 at which the base 12 is fed into the laminate unit 150. For example, the subsequent processing unit may include a device such as a cutting device configured to cut the glass lamination article 10, a scoring device configured to score edges of the glass lamination article 10, and a washing device configured to wash the surface of the glass lamination article 10, or a drying device configured to dry the surface of the glass lamination article 10.

In other embodiments, the laminate unit 150 may not include the ultraviolet irradiation device, and an additional ultraviolet irradiation unit (not shown) may be provided, such that the discharge unit 170 may be connected between the laminate unit 150 and the ultraviolet irradiation unit.

In other embodiments, an ultraviolet irradiation device (not shown) may be installed in the discharge unit 170 such that when bonded parts including the base 12, the adhesive layer 14, and the glass substrate layer 16 are discharged from the laminate unit 150 through the discharge unit 170, the adhesive layer 14 may be cured while passing through the ultraviolet irradiation device, and thus a glass lamination article 10 including the base 12, the adhesive layer 14, and the glass substrate layer 16 may be formed.

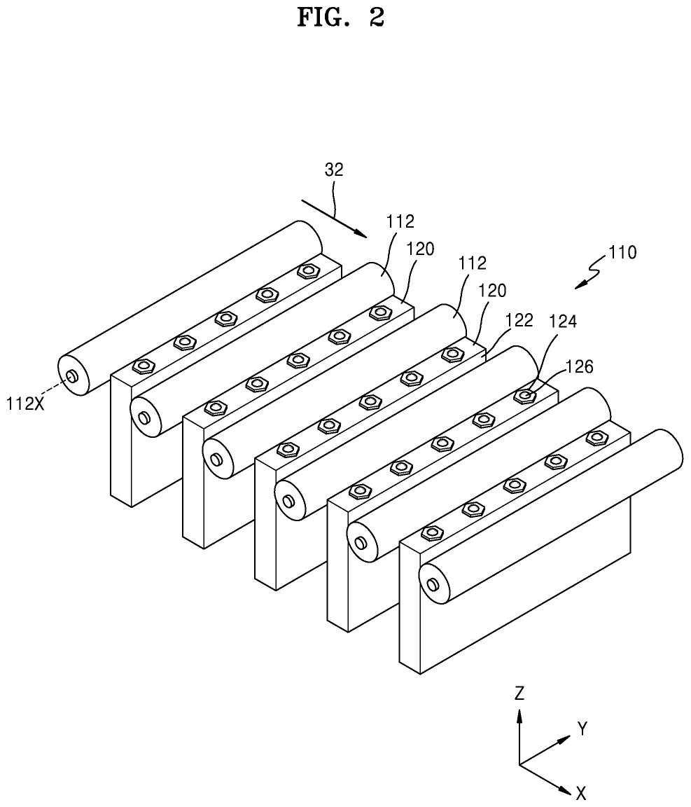

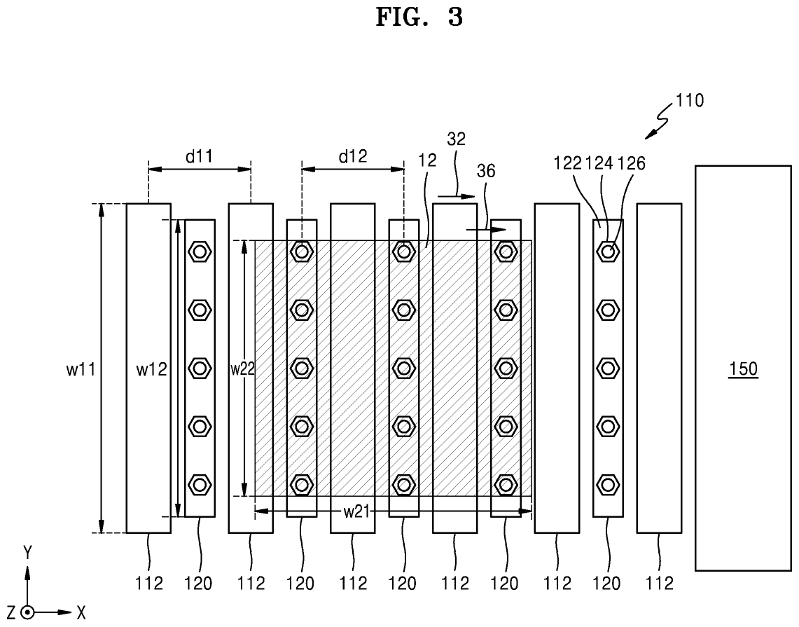

FIG. 2 is a perspective view illustrating the base supply unit 110 of the glass lamination article producing apparatus 100 shown in FIG. 1, according to example embodiments, and FIG. 3 is a top view illustrating the base supply unit 110. For ease of understanding, FIG. 3 illustrates that the base 12 is placed on an upper portion of the base supply unit 110.

Referring to FIGS. 2 and 3, the base supply unit 110 may include a plurality of convey rollers 112 and a plurality of centering bars 120. The base supply unit 110 transfers the base 12 toward the laminate unit 150 in the base transfer direction 32, and it is illustrated as an example that the base transfer direction 32 is substantially parallel to a first direction (X direction in FIG. 2).

The convey rollers 112 may extend in a second direction (Y direction in FIG. 3) and may be spaced apart from each other with a first distance d11 therebetween in the first direction (X direction in FIG. 3). In example embodiments, the first distance d11 may range from about 30 mm to about 300 mm. For example, the first distance d11 may range from about 30 mm to about 50 mm, from about 30 mm to about 100 mm, from about 30 mm to about 200 mm, from about 50 mm to about 100 mm, from about 50 mm to about 150 mm, from about 50 mm to about 200 mm, from about 100 mm to about 150 mm, from about 100 mm to about 200 mm, from about 100 mm to about 250 mm, from about 150 mm to about 200 mm, or from about 150 mm to about 300 mm. However, the first distance d11 is not limited thereto.

Each of the convey rollers 112 may have a first width w11 in the second direction (Y direction in FIG. 3). In example embodiments, the first width w11 may range from about 500 mm and about 2000 mm. For example, the first width w11 may range from about 500 mm to about 800 mm, from about 500 mm to about 1000 mm, from about 500 mm to about 1200 mm, from about 500 mm to about 1400 mm, from about 500 mm to about 1600 mm, from about 500 mm to about 1800 mm, from about 700 mm to about 800 mm, from about 700 mm to about 1000 mm, from about 700 mm to about 1200 mm, from about 700 mm to about 1400 mm, from about 700 mm to about 1600 mm, from about 700 mm to about 1800 mm, from about 700 mm to about 2000 mm, from about 1000 mm to about 1200 mm, from about 1000 mm to about 1400 mm, from about 1000 mm to about 1600 mm, from about 1000 mm to about 1800 mm, from about 1000 mm to about 2000 mm, from about 1200 mm to about 2000 mm, from about 1400 mm to about 2000 mm, from about 1500 mm to about 2000 mm, from about 1600 mm to about 2000 mm, or from about 1800 mm to about 2000 mm. However, the first width w11 is not limited thereto.

It is illustrated as an example that the convey rollers 112 are arranged at the same vertical level, but the technical idea of the present disclosure is not limited thereto. Each of the convey rollers 112 may rotate about a rotation axis 112X (for example, each of the convey rollers 112 may rotate clockwise about the rotation axis 112X as shown in FIG. 2), and thus, the base 12 placed on upper portions of the convey rollers 112 may be transferred in the base transfer direction 32, that is, the first direction (X direction).

Although not shown in FIGS. 2 and 3, the convey rollers 112 may be connected to and driven by a timing belt. For example, when the convey rollers 112 are coupled to and driven by a timing belt, the base 12 may be stably transferred. However, the technical idea of the present disclosure is not limited thereto, and in other embodiments, the convey rollers 112 may be connected to and driven by a timing chain.

In example embodiments, at least portions of the convey rollers 112 may include an elastic material, and in a non-limiting example, at least portions of the convey rollers 112 such as surfaces of the convey rollers 112 may include polyurethane resins. For example, when the convey rollers 112 include polyurethane resins, the base 12 may make stable contact with the base 12, and thus the base 2 may not slip on the convey rollers 112 or may not be misaligned with or offset from a target position.

Each of the centering bars 120 may be arranged between adjacent two of the convey rollers 112. The centering bars 120 may extend in the second direction (Y direction in FIG. 3) and may be spaced apart from each other with a second distance d12 therebetween in the first direction (X direction in FIG. 3). In example embodiments, the second distance d12 may range from about 30 mm to about 300 mm. Each of the centering bars 120 may include a base bar 122, ball housings 124, and convey balls 126.

Each of the centering bars 120 may have a second width w12 in the second direction (Y direction in FIG. 3). In example embodiments, the second width w12 may range from about 300 mm to about 3000 mm. For example, the second width w12 of each of the centering bars 120 may range from about 300 mm to about 500 mm, from about 300 mm to about 800 mm, from about 300 mm to about 1000 mm, from about 300 mm to about 1200 mm, from about 300 mm to about 1500 mm, from about 500 mm to about 800 mm, from about 500 mm to about 1000 mm, from about 500 mm to about 1500 mm, from about 500 mm to about 2000 mm, from about 700 mm to about 1000 mm, from about 700 mm To about 1500 mm, from about 700 mm to about 2000 mm, from about 1000 mm to about 1500 mm, from about 1000 mm to about 2000 mm, from about 1500 mm to about 2000 mm, from about 1000 mm to about 2500 mm, from about 1500 mm to about 2500 mm, or from about 1500 mm to about 3000 mm. However, the second width w12 of each of the centering bars 120 is not limited thereto.

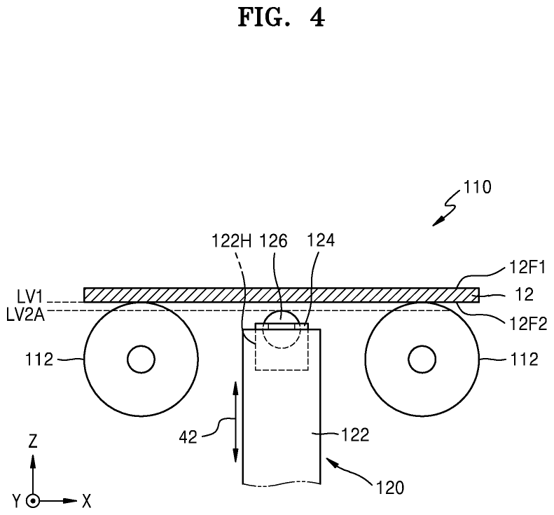

The base bar 122 may extend in the same direction as each of the convey rollers 112, for example, in the second direction (Y direction in FIG. 2). The base bar 122 may include a plurality of openings 122H (refer to FIG. 4), and the openings 122H may be arranged apart from each other with a predetermined distance therebetween in the second direction (Y direction in FIG. 2).

The ball housings 124 may be respectively mounted in the openings 122H, and lower portions of the convey balls 126 may be placed in the ball housings 124. For example, the lower portions of the convey balls 126 may be placed in the ball housings 124, and upper portions of the convey balls 126 may be placed at a vertical level higher than top surfaces of the ball housings 124 for being exposed to the outside of the ball housings 124. Upper sides of the convey balls 126 may protrude upward from a top surface of the base bar 122.

Although not shown in FIG. 4, a plurality of support balls (not shown) may be placed in the ball housings 124 and may be in contact with bottom surfaces of the convey balls 126. The support balls may be arranged under the convey balls 126 for rolling contact with lower surfaces of the convey balls 126, and when the convey balls 126 move in one direction, the support balls may move together with the convey balls 126 in a certain direction such that frictional resistance between the support balls and the convey balls 126 may be reduced. For example, the convey balls 126 may include a plastic material or a ceramic material, but are not limited thereto. For example, the support balls may include steel, stainless steel, or a ceramic material, but are not limited thereto.

The centering bars 120 may be connected to a height adjustment device (not shown), and therefore, the height of each of the centering bars 120 may be adjustable. A position sensor (not shown) may be connected to the centering bars 120 to enable alignment or movement of the base 12 in a horizontal direction (Y direction in FIG. 2).

FIG. 4 is a front view schematically illustrating the base supply unit 110 in a transfer mode. For ease of illustration, FIG. 4 illustrates an example in which a base 12 having a first surface 12F1 and a second surface 12F2 is placed on the convey rollers 112 and the centering bars 120, and an adhesive layer 14 that may be provided on the first surface 12F1 of the base 12 is not shown.

Referring to FIG. 4, in the transfer mode, the centering bars 120 may be moved downward in a height adjustment direction 42, and therefore, the top surface level LV2A of the centering bars 120 may be lower than the top surface level LV1 of the convey rollers 112. Here, the top surface level LV2A of the centering bars 120 may refer to the top surface level of the convey balls 126. Since the top surface level LV2A of the centering bars 120 is lower than the top surface level LV1 of the convey rollers 112, the second surface 12F2 of the base 12 may be in contact with and supported by the convey rollers 112, but not in contact with the centering bars 120, for example, top surfaces of the convey balls 126. In the transfer mode, the base 12 may be aligned in a direction 36 substantially parallel to the base transfer direction 32 and may be moved in the base transfer direction 32 by the rotation of the convey rollers 112.

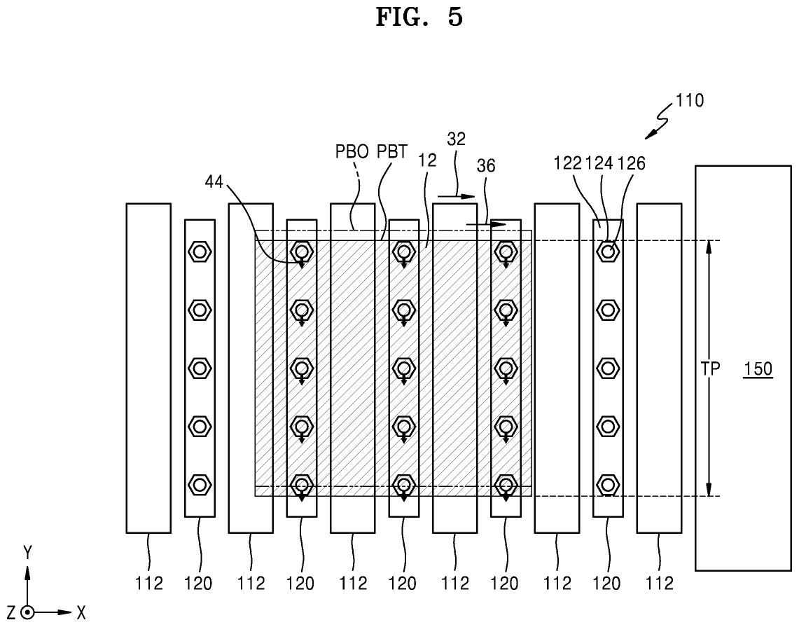

When the base 12 is loaded on the convey rollers 112 and aligned in a direction 36 not parallel to the base transfer direction 32, the base 12 may be fed into the laminate unit 150 in a state in which the base 12 is misaligned with or offset from a target feeding position TP (refer to FIG. 5) of the laminate unit 150. In this case, the position of the base 12 may be adjusted using the centering bars 120.

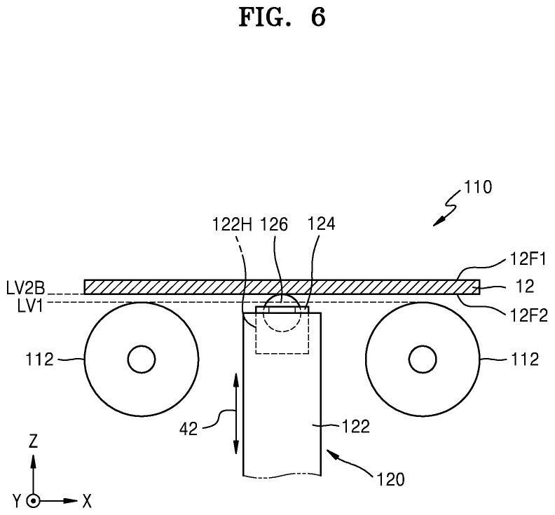

FIG. 5 is a top view schematically illustrating the base supply unit 110 in a position adjustment mode, and FIG. 6 is a front view schematically illustrating the base supply unit 110 in the position adjustment mode. As shown in FIGS. 5 and 6, when the base 12 is offset from or misaligned with the target feeding position TP of the laminate unit 150 by a certain width in the second direction (Y direction) (that is, when the base 12 is placed at an offset position PBO), the centering bars 120 may be driven. The centering bars 120 may be moved upward in the height adjustment direction 42, and therefore, the top surface level LV2B of the centering bars 120 may be higher than the top surface level LV1 of the convey rollers 112. Since the top surface level LV2B of the centering bars 120 is higher than the top surface level LV1 of the convey rollers 112, the second surface 12F2 of the base 12 is in contact with and supported by top surfaces of the centering bars 120, for example, the top surfaces of the convey balls 126, but is not in contact with top surfaces of the convey rollers 112.

In the position adjustment mode, due to the position sensor (not shown) connected to the centering bars 120, the base 12 may be moved in the horizontal direction (Y direction in FIG. 5) by using the convey balls 126. For example, when the base 12 is offset from or misaligned with the target feeding position TP by a certain distance in the second direction (Y direction in FIG. 5) (that is, when the base 12 is at an offset position PBO as shown in FIG. 5), the base 12 may be moved in an alignment direction 44 which is opposite to the second direction (Y direction in FIG. 5) by moving the convey balls 126 in the alignment direction 44, and thus the base 12 may be aligned with the target feeding position TP (that is, the base 12 may be placed at a target position PBT as shown in FIG. 5). Therefore, the position of the base 12 may be precisely adjusted on the base supply unit 110.

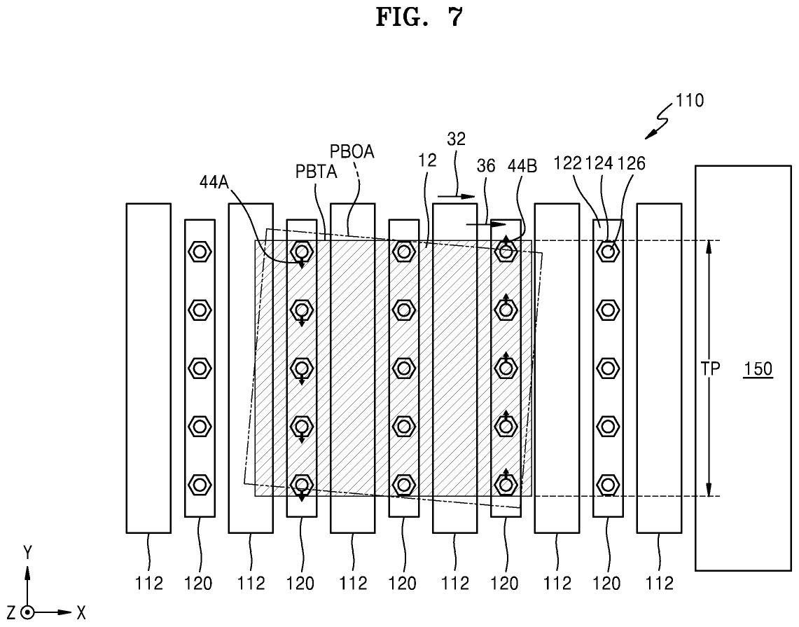

FIG. 7 is a top view schematically illustrating the base supply unit 110 in the position adjustment mode according to other embodiments. For example, when the base 12 is offset from or misaligned with the target feeding position TP of the laminate unit 150 by a certain angle (that is, when the base 12 is at an offset position PBOA as shown in FIG. 7), the convey balls 126 of at least one of the centering bars 120 may be moved in a first alignment direction 44A, and the convey balls 126 of at least one of the other centering bars 120 may be moved in a second alignment direction 44B. For example, if required depending on the offset position PBOA of the base 12, the convey balls 126 of each of the centering bars 120 may be moved in different directions, or may be moved different distances in the same direction, or may be moved different distances in different directions. As a result, the base 12 may be aligned with the target feeding position TP, and for example, the base 12 may be placed at a target position PBTA. Therefore, the position of the base 12 may be precisely adjusted on the base supply unit 110.

Referring back to FIG. 3, the convey rollers 112 and the centering bars 120 may be alternately arranged in the first direction (X direction in FIG. 3). Since the base supply unit 110 includes the convey rollers 112 and the centering bars 120, the base 12 may be moved in the second direction (Y direction in FIG. 3) at any position before the base 12 is fed into the laminate unit 150, and thus the position of the base 12 may be precisely adjusted when the base 12 is fed into the laminate unit 150. Moreover, when the base 12 is offset or misaligned even after a portion of the base 12 is fed into the laminate unit 150, the base 12 may be moved in the second direction (Y direction in FIG. 3), and thus the position of the base 12 may be precisely adjusted while the base 12 is fed into the laminate unit 150.

The base 12, which is moved on the base supply unit 110 in the base transfer direction 32, that is, in the first direction (X direction) and is fed into the laminate unit 150, may have a first width w21 in the first direction (X direction) and a second width w22 in the second direction (Y direction).

In example embodiments, the first width w21 of the base 12 may range from about 300 mm and about 2000 mm. For example, the first width w21 of the base 12 may range from about 300 mm to about 500 mm, from about 300 mm to about 800 mm, from about 300 mm to about 1000 mm, from about 300 mm to about 1200 mm, from about 300 mm to about 1500 mm, from about 500 mm to about 800 mm, from about 500 mm to about 1000 mm, from about 500 mm to about 1500 mm, from about 500 mm to about 2000 mm, from about 700 mm to about 1000 mm, from about 700 mm To about 1500 mm, from about 700 mm to about 2000 mm, from about 1000 mm to about 1500 mm, from about 1000 mm to about 2000 mm, or from about 1500 mm to about 2000 mm. However, the first width w21 of the base 12 is not limited thereto.

In example embodiments, the second width w22 of the base 12 may range from about 300 mm to about 3000 mm. For example, the second width w22 of the base 12 may range from about 300 mm to about 500 mm, from about 300 mm to about 800 mm, from about 300 mm to about 1000 mm, from about 300 mm to about 1200 mm, from about 300 mm to about 1500 mm, from about 500 mm to about 800 mm, from about 500 mm to about 1000 mm, from about 500 mm to about 1500 mm, from about 500 mm to about 2000 mm, from about 700 mm to about 1000 mm, from about 700 mm To about 1500 mm, from about 700 mm to about 2000 mm, from about 1000 mm to about 1500 mm, from about 1000 mm to about 2000 mm, from about 1500 mm to about 2000 mm, from about 1000 mm to about 2500 mm, from about 1500 mm to about 2500 mm, or from about 1500 mm to about 3000 mm. However, the second width w22 of the base 12 is not limited thereto.

For example, at any position while the base 12 is transferred, the base supply unit 110 may adjust the positional offset or misalignment of the base 12 by using the centering bars 120 arranged between the convey rollers 112, and thus the installation of a device such as an expensive camera system for position inspection may not be required.

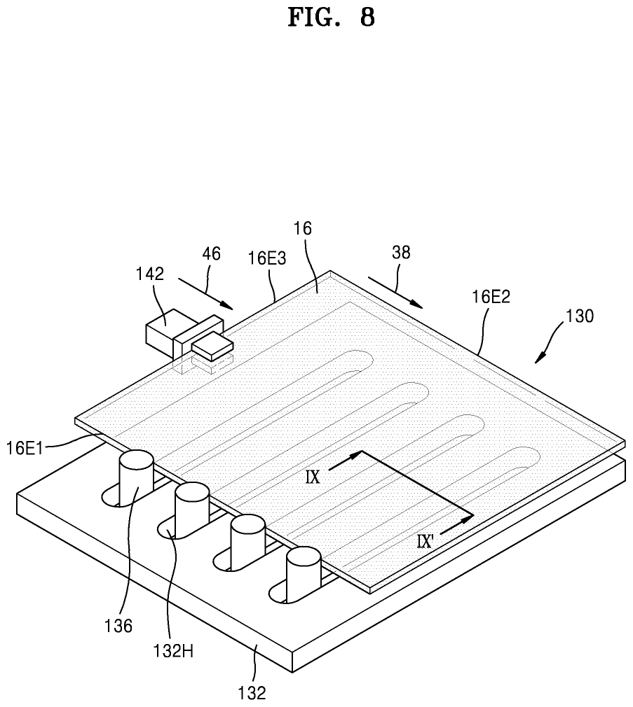

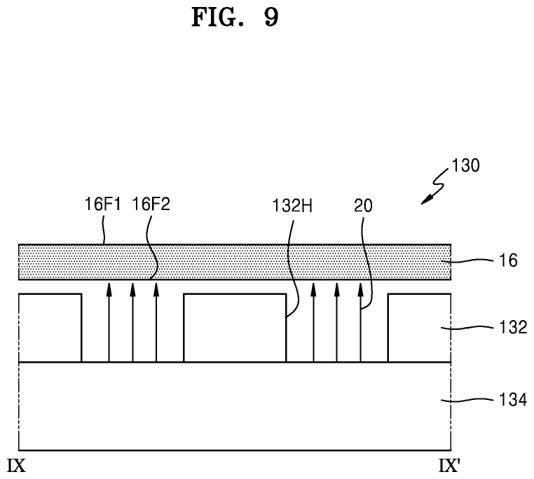

FIG. 8 is a perspective view illustrating the glass supply unit 130 of the glass lamination article producing apparatus 100 shown in FIG. 1, according to example embodiments, and FIG. 9 is a cross-sectional view taken along line IX-IX′ of FIG. 8.

As shown in FIGS. 8 and 9, the glass supply unit 130 may include a glass feeding part 132, a gas spraying device 134, guide members 136, and a gripper 142.

In example embodiments, the glass feeding part 132 may be arranged at a vertical level higher than the base supply unit 110 such that a glass substrate layer 16 may be placed on a top surface of the glass feeding part 132 and fed into the laminate unit 150. In example embodiments, the glass feeding part 132 may be arranged at a vertical level higher than the base supply unit 110 and may be spaced apart from the laminate unit 150 by a predetermined distance. In other embodiments, the glass feeding part 132 may be configured to be moved together with the glass substrate layer 16 by a predetermined distance toward the laminate unit 150 in a glass transfer direction 38 by a driving motor (not shown) coupled to the glass feeding part 132.

In example embodiments, the glass feeding part 132 may include a plurality of through-holes 132H, and the gas spraying device 134 may be arranged under the glass feeding part 132. The gas spraying device 134 may be configured to spray gas 20 through the through-holes 132H of the glass feeding part 132, and thus the glass substrate layer 16 arranged on the glass feeding part 132 may be floated from the top surface of the glass feeding part 132 by the gas 20 ejected from the gas spraying device 134. For example, the glass substrate layer 16 is floated from the top surface of the glass feeding part 132 by gas 20 ejected from the gas spraying device 134, and thus a second surface 16F2 of the glass substrate layer 16 is not directly in contact with the top surface of the glass feeding part 132, thereby reducing the contact resistance between the glass substrate layer 16 and the glass feeding part 132 and preventing or reducing unintended slipping, offset, or misalignment of the glass substrate layer 16 that otherwise can occur when the glass substrate layer 16 is moved toward and fed into the laminate unit 150.

In example embodiments, the driving of the first roller 152 and the second roller 154 of the laminate unit 150 (refer to FIG. 1), the driving of the convey rollers 112 of the base supply unit 110, and the driving of the glass feeding part 132 of the glass supply unit 130 may be synchronized with each other. For example, the first roller 152, the second roller 154, the convey rollers 112, and the glass feeding part 132 may be connected to a servo motor (not shown), and the rotation speeds of the first roller 152 and the second roller 154, the rotation speeds of the convey rollers 112, and the speed of the glass feeding part 132 may be synchronized with each other. Therefore, the speed of the base 12 on the base supply unit 110 may be substantially equal to the speed of the base 12 passing between the first roller 152 and the second roller 154 of the laminate unit 150, and the speed of the glass substrate layer 16 on the glass supply unit 130 may be substantially equal to the speedof the base 12 and the glass substrate layer 16 passing between the first roller 152 and the second roller 154 of the laminate unit 150.

The guide members 136 may be arranged on the glass feeding part 132. As shown in FIG. 8, the glass substrate layer 16 includes a first edge 16E1, a second edge 16E2 which is opposite the first edge 16E1, and a third edge 16E3 connected to both the first and second edges 16E1 and 16E2. Here, the first edge 16E1 and the second edge 16E2 refer to edge faces of the glass substrate layer 16 which are substantially parallel with the glass transfer direction 38. When the glass substrate layer 16 is loaded on the glass feeding part 132, the guide members 136 may function as stoppers that stop the glass substrate layer 16 by making contact with the first edge 16E1 of the glass substrate layer 16. In addition, when the glass substrate layer 16 is moved together with the glass feeding part 132 toward the laminate unit 150, the guide members 136 may make contact with the first edge 16E1 of the glass substrate layer 16 to reduce or prevent unintended slipping, offset, or misalignment of the glass substrate layer 16.

As shown in FIG. 8, lower portions of the guide members 136 may be arranged in the through-holes 132H, and top surfaces of the guide members 136 may be arranged at a level higher than the top surface of the glass feeding part 132. Therefore, regardless of the operation of the gas spraying device 134, that is, in both the case in which the glass substrate layer 16 is floated from the top surface of the glass feeding part 132 and the case in which the glass substrate layer 16 is in contact with the top surface of the glass feeding part 132, the guide members 136 may function as stoppers for the glass substrate layer 16.

Although FIG. 8 illustrates an example in which the guide members 136 are respectively provided in the through-holes 132H, the technical idea of the present disclosure is not limited thereto. In other embodiments, the guide members 136 may be attached to the top surface of the glass feeding part 132 at positions outside the through-holes 132H, and in other embodiments, the guide members 136 may be attached to a side surface of the glass feeding part 132.

In example embodiments, the gripper 142 may move the glass substrate layer 16 onto the glass feeding part 132 by gripping an edge of the glass substrate layer 16 (for example, the third edge 16E3 shown in FIG. 8), and when moving the glass substrate layer 16 from the glass feeding part 132 to the laminate unit 150, the gripper 142 may fixedly grip the edge of the glass substrate layer 16 (for example, the third edge 16E3 shown in FIG. 8) and move a predetermined distance in the glass transfer direction 38. For example, the gripper 142 may hold the third edge 16E3 of the glass substrate layer 16 and move together with the glass substrate layer 16 toward the laminate unit 150 while the glass substrate layer 16 is transferred by a predetermined length after being fed into the laminate unit 150. The movement direction 46 of the gripper 142 may be substantially the same as the glass transfer direction 38.

The gripper 142 may move together with the glass substrate layer 16 by a predetermined distance and may release the glass substrate layer 16 at a stop position. For example, the distance between the stop position and the laminate unit 150 may range from about 100 mm to about 1000 mm, from about 100 mm to about 300 mm, from about 300 mm to about 500 mm, from about 300 mm to about 700 mm, or from about 500 mm to about 1000 mm, but is not limited thereto. The stop position may be appropriately selected according to factors such as the width and thickness of the glass substrate layer 16, and/or the size and type of the base 12. For example, when the stop position is too close to the laminate unit 150, the gripper 142 may make contact or collide with the base 12 located under the gripper 142, and when the stop position is too distant from the laminate unit 150, position offset or misalignment may occur while the glass substrate layer 16 is fed into the laminate unit 150.

In example embodiments, the gripper 142 may be a pneumatic gripper. FIG. 8 shows an example in which the gripper 142 is a parallel gripper, but unlike this, the gripper 142 may be an angular gripper. In other embodiments, the gripper 142 may be a non-contact gripper.

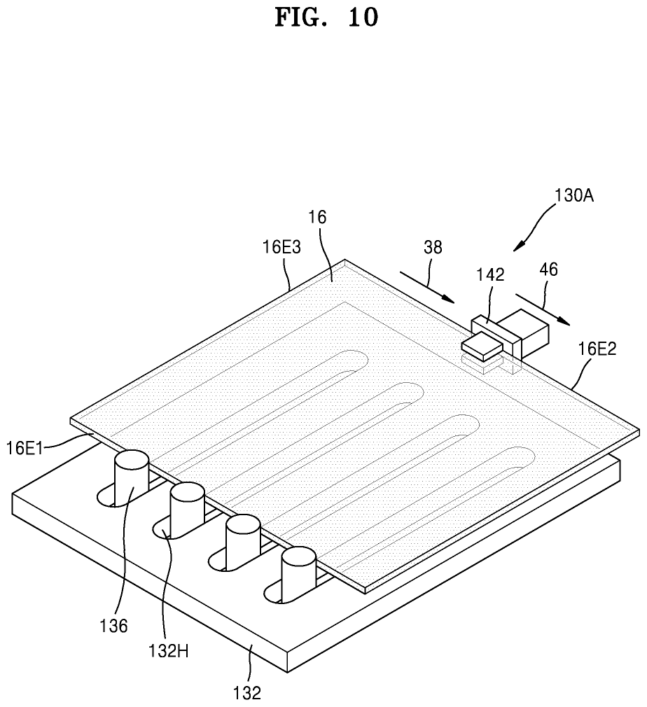

FIG. 10 is a perspective view schematically illustrating a glass supply unit 130A according to other embodiments. Referring to FIG. 10, a gripper 142 may hold an edge of a glass substrate layer 16 which is opposite an edge of the glass substrate layer 16 making contact with guide members 136, and may move the glass substrate layer 16 by a predetermined distance. For example, the guide members 136 may make contact with a first edge 16E1 of the glass substrate layer 16, and the gripper 142 may move a predetermined distance in the movement direction 46 parallel to the glass transfer direction 38 while gripping a second edge 16E2 of the glass substrate layer 16 and may release the glass substrate layer 16 at a stop position.

In general, glass lamination articles have a relatively small thickness, and a method using a transparent adhesive film or ultraviolet irradiation is widely used to bond a base and a glass substrate layer to each other. However, when a transparent adhesive film is used, surface waviness may be present after bonding.

In addition, when an ultraviolet irradiation method of the related art is used to form a large-area glass lamination article, at least one of a base and a glass substrate layer of the glass lamination article may slip or positionally deviate, causing aesthetic incompleteness such as bubbles in the glass lamination article. In addition, when at least one of a base or a glass substrate layer of a large-area glass lamination article slip or move during a bonding process, the thickness of the glass lamination article may locally increase or decrease, and thus color unevenness may be present in the entire area of the glass lamination article. Therefore, when an ultraviolet irradiation method is used to form a large-area glass lamination article, it is difficult to guarantee sufficient appearance quality.

However, according to the glass lamination article producing apparatus 100 described with reference to FIGS. 1 to 10, when a base 12 is fed into the laminate unit 150, misalignment or offset of the base 12 may be prevented owing to the convey rollers 112 and the centering bars 120 which are alternately arranged in the base supply unit 110. Furthermore, in the glass supply unit 130 provided at a vertical level higher than the base supply unit 110, a glass substrate layer 16 may be fed into the laminate unit 150 while being held by the gripper 142 along the glass feeding part 132. Therefore, slip or positional offset between the base 12 and the glass substrate layer 16 may be prevented, and the formation of aesthetic incompleteness such as bubbles, which otherwise can occur when the base 12 and the glass substrate layer 16 are bonded together, may be reduced or prevented. In addition, the base 12 and the glass substrate layer 16 may be prevented from moving relatively to each other during the bonding process thereof, a glass lamination article 10 having relatively small thickness variations may be produced.

In conclusion, according to the example embodiments, the glass lamination article producing apparatus 100 may produce glass lamination articles 10 having large areas and high appearance quality.

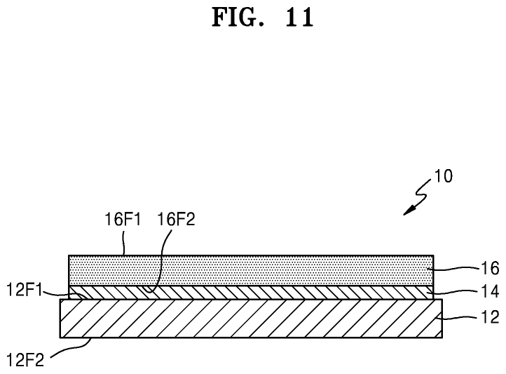

FIG. 11 is a cross-sectional view schematically illustrating a glass lamination article 10 by the glass lamination article producing apparatus 100 of the example embodiments.

Referring to FIG. 11, the glass lamination article 10 may include a base 12, an adhesive layer 14, and a glass substrate layer 16.

The base 12 may include a first surface 12F1 and a second surface 12F2, and the adhesive layer 14 may be on the first surface 12F1 of the base 12. The glass substrate layer 16 may include a first surface 16F1 and a second surface 16F2, and the second surface 16F2 of the glass substrate layer 16 may face the first surface 12F1 of the base 12 and may be in contact with the adhesive layer 14.

The base 12 may be a metal substrate, a wooden substrate, an inorganic substrate, an organic substrate, or a composite material thereof. The metal substrate may include steel, aluminum, copper, or a metal alloy, but is not limited thereto.

In some embodiments, the base 12 may be a metal substrate, a wooden substrate, an inorganic substrate, an organic substrate, or a composite material thereof which is coated with an organic film. In some embodiments, the base 12 may be a metal substrate, a wooden substrate, an inorganic substrate, an organic substrate, or a composite material thereof which is coated with paint.

In some embodiments, the base 12 may be a high pressure laminate (HPL), a paint-coated metal (PCM), or a vinyl-coated metal (VCM). In some embodiments, the base 12 may be a material that is used for wall panels, backsplashes, cabinets or furniture exteriors, home appliance exteriors, or other architectural applications.

The adhesive layer 14 may include an adhesive resin material and may be used to bond the base 12 and the glass substrate layer 16 together. In some embodiments, the adhesive layer 14 may include a material selected from photocurable resins. In some embodiments, the adhesive layer 14 may include an ultraviolet (UV)-curable resin.

In some embodiments, the adhesive layer 14 may include, for example, an acrylic resin or an epoxy resin. The acrylic resin may include: a homopolymer having a single type of monomer selected from the group consisting of monomers such as methyl(meth)acrylate, ethyl(meth)acrylate, butyl(meth)acrylate, dimethylaminoethyl(meth)acrylate, isobutyl(meth)acrylate, t-butyl(meth)acrylate, cyclohexyl(meth)acrylate, ethylhexyl(meth)acrylate, tetrahydrofurfuryl(meth)acrylate, hydroxyethyl(meth)acrylate, tetrafluoropropyl(meth)acrylate, or tricyclodecane dimethanol di(meth)acrylate; a copolymer having two or more types of monomers selected from the group; or a mixture of the homopolymer and the copolymer.

In some embodiments, the adhesive layer 14 may include: a homopolymer selected from the group consisting of bisphenol A type epoxy, bisphenol F type epoxy, hydrogenated bisphenol A type epoxy, hydrogenated bisphenol F type epoxy, bisphenol S type epoxy, brominated bisphenol A type epoxy, biphenyl type epoxy, naphthalene type epoxy, fluorene type epoxy, spiro ring type epoxy, bisphenol alkane epoxy, phenol novolak type epoxy, orthocresol novolak type epoxy, brominated cresol novolak type epoxy, trishydroxymethane type epoxy, tetraphenylolethane type epoxy, alicyclic epoxy, and alcohol type epoxy; a copolymer having two or more selected from the group; or a mixture of the homopolymer and the copolymer.

Examples of a commercially available product, which may be used as the adhesive layer 14, include, but are not limited to, Henkel's 3193HS, 3381, 3311, and 3103 (acrylic resins), and 3335 (epoxy resin).

The adhesive layer 14 may have a thickness of about 10 micrometers (μm) to about 200 μm. In some embodiments, the adhesive layer 14 may have a thickness of about 15 μm to about 150 μm, about 20 μm to about 100 μm, about 25 μm to about 70 μm, or about 30 μm to about 50 μm.

The glass substrate layer 16 may include glass having SiO₂ in an amount of about 30 mol % to 85 mol %, Al₂O₃ in an amount of about 1 mol % to 25 mol %, B₂O₃ in an amount of about 0.1 mol % to 15 mol %, MgO in an amount of about 0.1 mol % to 10 mol %, and CaO in an amount of 0.1 mol % to 10 mol %. In some embodiments, the glass substrate layer 16 may further include Li₂O, K₂O, ZnO, SrO, BaO, SnO₂, TiO₂, V₂O₃, Nb₂O₅, MnO, ZrO₂, As₂O₃, MoO₃, Sb₂O₃, and/or CeO₂, but is not limited thereto.

The glass substrate layer 16 may have a thickness of about 50 micrometers (μm) to about 500 μm. In some embodiments, the glass substrate layer 16 may have a thickness of about 80 μm to about 400 μm, about 100 μm to about 350 μm, about 120 μm to about 300 μm, or about 150 μm to about 250 μm.

The glass substrate layer 16 may have a transmittance of about 90% or more with respect to visible light. In some embodiments, the glass substrate layer 16 has a transmittance of about 93% or more, about 95% or more, about 96% or more, about 97% or more, about 98% or more, or about 99% or more with respect to visible light.

The glass lamination article 10, produced by the glass lamination article producing apparatus 100 of the example embodiments, may not have bubbles between the adhesive layer 14 and the glass substrate layer 16 because misalignment or offset between the base 12 and the glass substrate layer 16 is prevented during a process of bonding the base 12 and the glass substrate layer 16. In addition, the glass lamination article 10 may have a uniform thickness over the entire area of the glass lamination article 10. Therefore, even when the glass lamination article 10 has a relatively large area, the glass lamination article 10 may have high appearance quality such as bubble-free and uniform thickness characteristics.

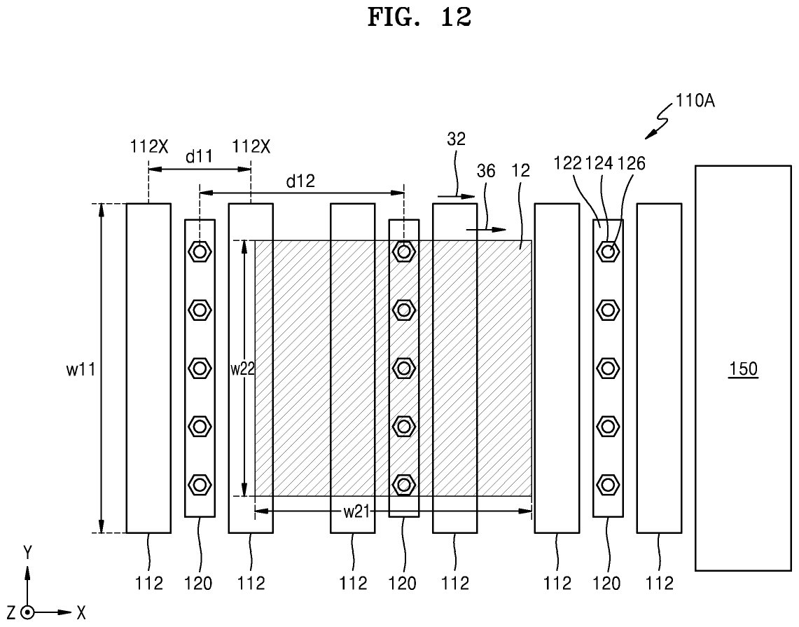

FIG. 12 is a top view schematically illustrating a base supply unit 110A according to example embodiments.

Referring to FIG. 12, a plurality of convey rollers 112 may extend in a first direction (Y direction) and may be arranged at a first distance d11 from each other in a second direction (X direction). A plurality of centering bars 120 may be arranged such that one centering bar 120 may be between two convey rollers 112, and for example, each centering bar 120 may be arranged next to an odd-numbered convey roller 112 or an even-numbered convey roller 112. As shown in FIG. 12, two convey rollers 112 and one centering bar 120 may be sequentially and repeatedly arranged in the second direction (X direction).

Although FIG. 12 illustrates an example in which the convey rollers 112 are spaced apart from each other at the same first distance d11 from each other, the distance between two convey rollers 112 having a centering bar 120 arranged therebetween may be adjusted to be greater than the distance between two convey rollers 112 having no centering bar 120 arranged therebetween.

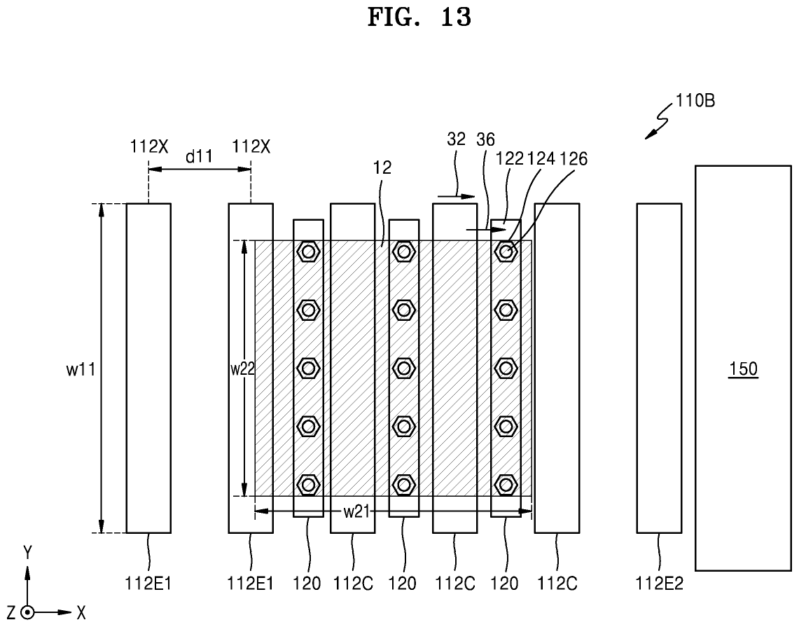

FIG. 13 is a top view schematically illustrating a base supply unit 1106 according to example embodiments.

Referring to FIG. 13, a plurality of convey rollers 112 may include a plurality of first edge convey rollers 112E1, a plurality of central convey rollers 112C, and at least one second edge convey roller 112E2. The second edge convey roller 112E2 may be closest to the laminate unit 150, and the first edge convey rollers 112E1 may be farthest from the laminate unit 150. Each of a plurality of centering bars 120 may be arranged between two adjacent central convey rollers 112C of the central convey rollers 112C.

Although FIG. 13 illustrates an example in which the first edge convey rollers 112E1, the central convey rollers 112C, and the second edge convey roller 112E2 are spaced apart from each other at the same first distance d11 from each other, the distance between two central convey rollers 112C having a centering bar 120 arranged therebetween may be adjusted to be greater than the distance between two convey rollers 112 such as the first and second edge convey rollers 112E1 and 112E2 having no centering bar 120 arranged therebetween.

According to example embodiments, when a base 12 is positioned on the central convey rollers 112C on a center portion of the base supply unit 1106, the position of the base 12 may be precisely adjusted in a second direction (X direction).

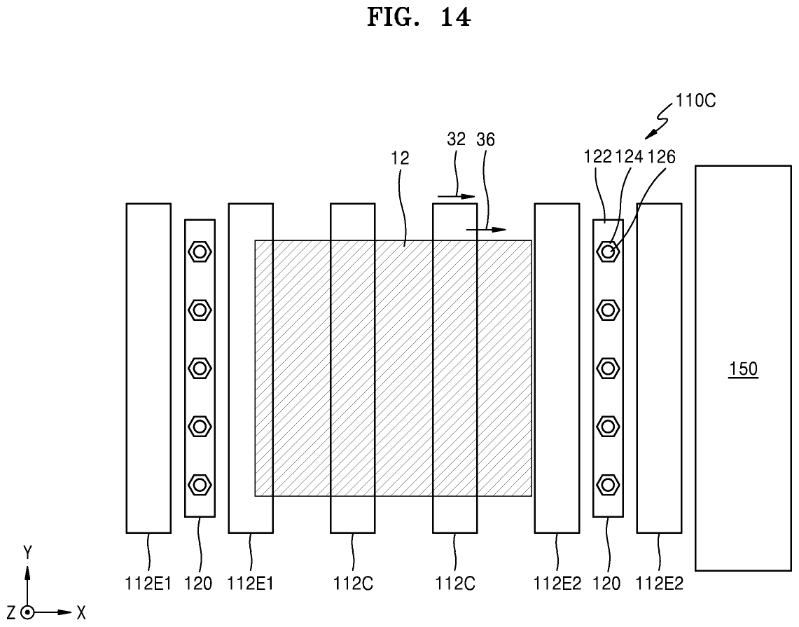

FIG. 14 is a top view schematically illustrating a base supply unit 110C according to example embodiments.

Referring to FIG. 14, a plurality of convey rollers 112 may include a plurality of first edge convey rollers 112E1, a plurality of central convey rollers 112C, and a plurality of second edge convey rollers 112E2. The second edge convey rollers 112E2 may be closest to the laminate unit 150, and the first edge convey rollers 112E1 may be farthest from the laminate unit 150. A plurality of centering bars 120 may be arranged between the first edge convey rollers 112E1 and between the second edge convey rollers 112E2.

According to example embodiments, when a base 12 is positioned on the first edge convey rollers 112E1 and is positioned on the second edge convey rollers 112E2, the position of the base 12 may be precisely adjusted in a second direction (X direction).

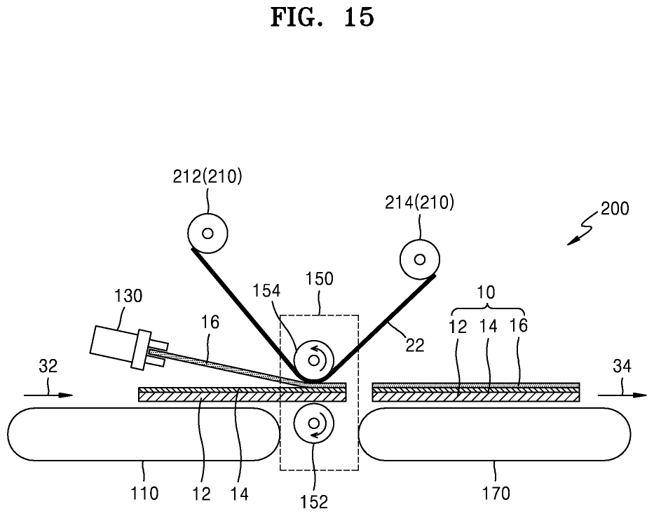

FIG. 15 is a schematic view illustrating an apparatus 200 for producing glass lamination articles according to example embodiments.

Referring to FIGS. FIG. 15, the glass lamination article producing apparatus 200 may further include an absorptive member supply unit 210, and the absorptive member supply unit 210 may include first and second absorptive member supply rollers 212, 214. The first and second absorptive member supply rollers 212 and 214 may be respectively connected to both ends of an absorptive member 22 such that the absorptive member 22 may pass between a first roller 152 and a second roller 154 of a laminate unit 150. For example, the absorptive member 22 may be arranged between the second roller 154 and a glass substrate layer 16 and may pass between the first roller 152 and the second roller 154.

When a base 12, an adhesive layer 14 attached on an upper portion of the base 12, and a glass substrate layer 16 pass between the first roller 152 and the second roller 154 such that the glass substrate layer 16 is attached to the base 12, the absorptive member 22 may absorb a material of the adhesive layer 14 which may leak between edges of the base 12 and the glass substrate layer 16.

In general, when the adhesive layer 14 is a viscous liquid or a gel-type solid having fluidity, the adhesive layer 14 arranged between the glass substrate layer 16 and the base 12 may be locally moved. For example, the adhesive layer 14 may be moved by the movement of the glass substrate layer 16 and/or the base 12, and thus thickness of the adhesive layer 14 may locally vary. In addition, the thickness of the adhesive layer 14 may be relatively large at edge portions of the base 12 and the glass substrate layer 16, or the adhesive layer 14 may flow out from the edge portions of the base 12 and the glass substrate layer 16. In these cases, aesthetic incompleteness such as bubbles may be formed in a glass lamination article 10, or the thickness of the glass lamination article 10 may be locally increased or decreased, causing color unevenness over the entire area of the glass lamination article 10.

However, according to example embodiments, slip or positional offset between the base 12 and the glass substrate layer 16 may be prevented by the base supply unit 110 and the glass supply unit 130, and the absorptive member 22 may absorb a material of the adhesive layer 14 leaking between the edges of the glass substrate layer 16 and the base 12. Therefore, it is possible to reduce or prevent color unevenness caused by aesthetic incompleteness such as bubbles in the glass lamination article 10 or uneven thickness of the glass lamination article 10.

Therefore, according to example embodiments, the glass lamination article producing apparatus 200 may produce glass lamination articles 10 which have high appearance quality even though the glass lamination articles 10 have a large area.

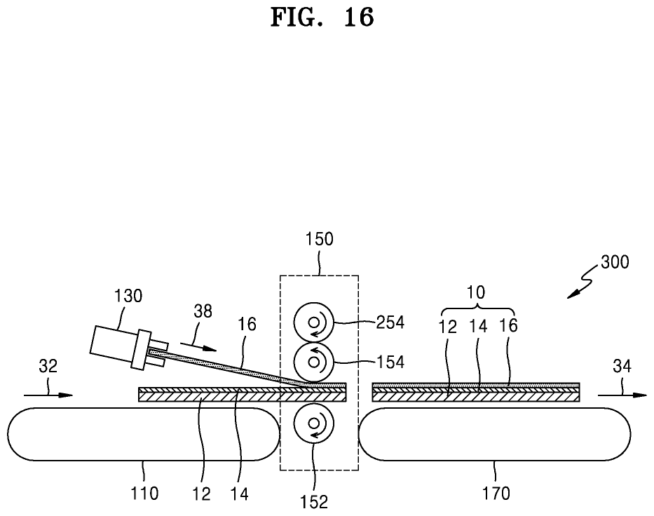

FIG. 16 is a schematic view illustrating an apparatus 300 for producing glass lamination articles according to example embodiments.

Referring to FIG. 16, the glass lamination article producing apparatus 300 may further include a third roller 254 included in a laminate unit 150.

In example embodiments, the third roller 254 may be located at a vertical level higher than a second roller 154, and may be in contact with the second roller 154 and may be configured to be rotated in a direction opposite to the rotation direction of the second roller 154. For example, a bottom surface of the third roller 254 may be in contact with a top surface of the second roller 154 across the entire length of the third roller 254. When a base 12 and a glass substrate layer 16 pass between a first roller 152 and the second roller 154, the third roller 254 provide downward pressure uniformly across the entire length of the second roller 154. Therefore, when a glass lamination article 10 passes between the first roller 152 and the second roller 154, the thickness of the glass lamination article 10 may not locally vary (for example, the thickness of portions of the glass lamination article 10 passing under both ends of the second roller 154 may not be different from the thickness of a portion of the glass lamination article 10 passing under a center portion of the glass lamination article 10).

In other example embodiments, the third roller 254 may be spaced apart from the second roller 154 by a predetermined separation distance, and for example, the separation distance may be about 0.1 mm to about 5 mm, but is not limited thereto.

Therefore, according to example embodiments, the glass lamination article producing apparatus 300 may produce glass lamination articles 10 which have high appearance quality even though the glass lamination articles 10 have a large area.

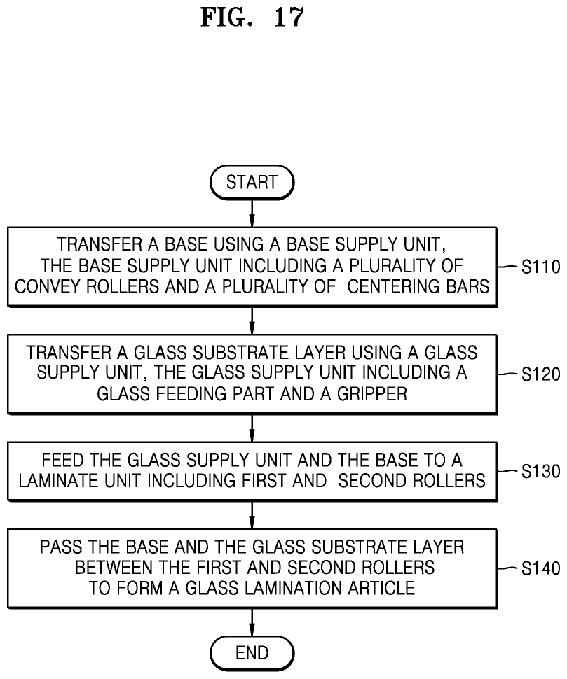

FIG. 17 is a flowchart illustrating a method of producing glass lamination articles according to example embodiments. The glass lamination article producing method may be a method of producing the glass lamination article 10 described with reference to FIG. 11 by using any one of the glass lamination article producing apparatuses 100, 200, and 300 described with reference to FIGS. 1 to 10 and 12 to 16.

Referring to FIG. 17, a base may be transferred using a base supply unit (operation S110). The base supply unit may include a plurality of convey rollers extending in a first direction and a plurality of centering bars each arranged between two of the convey rollers in a height adjustable manner. The operation S110 of transferring the base may include transferring the base in a second direction perpendicular to the first direction by using the convey rollers, and adjusting the position of the base in the first direction by using the centering bars.

In example embodiments, the transferring of the base is performed such that top surfaces of the centering bars may be located at a level lower than top surfaces of the convey rollers and a bottom surface of the base may not be in contact with the top surfaces of the centering bars, and the adjusting of the position of the base is performed such that the top surfaces of the centering bars may be located at a level higher than the top surfaces of the convey rollers and the bottom surface of the base may be in contact with the top surfaces of the centering bars.

In example embodiments, each of the centering bars may include: a base bar extending in the first direction and having a plurality of openings; and convey balls arranged in the openings of the base bar and protruding upward from a top surface of the base bar.

A glass substrate layer may be transferred using a glass supply unit (operation S120). The glass supply unit may include a glass feeding part and a gripper. The glass feeding part may include a plurality of through-holes, and the glass supply unit may further include a gas spraying device arranged below the glass feeding part.

In example embodiments, the operation S120 of transferring the glass substrate layer may include: spraying gas onto a bottom surface of the glass substrate layer placed on the glass feeding part by using the gas spraying device; and moving the glass substrate layer toward a laminate unit while holding an edge of the glass substrate layer with the gripper.

The base and the glass substrate layer may be fed into the laminate unit which includes a first roller and a second roller (operation S130).

A glass lamination article may be formed by passing the base and the glass substrate layer between the first roller and the second roller to attach the glass substrate layer to the base (operation S140).

According to the method of producing glass lamination articles of the example embodiments, the convey rollers and the centering bars, which are alternately arranged in the base supply unit, may prevent misalignment or offset of the base when the base is fed into the laminate unit. Furthermore, in the glass supply unit provided at a vertical level higher than the base supply unit, the glass substrate layer may be held by the gripper on the glass feeding part, and may be fed into the laminate unit. Therefore, slip or positional offset between the base and the glass substrate layer may be prevented, and when the base and the glass substrate layer are bonded together, the formation of aesthetical incompleteness such as bubbles may be reduced or prevented. In addition, relative movement between the base and the glass substrate layer may be prevented in the bonding process, and thus variations in the thickness of the glass lamination article may be reduced or prevented.

Therefore, according to example embodiments, glass lamination articles, which have high appearance quality even when the glass lamination articles have a large area, may be produced by the glass lamination article producing method.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. An apparatus for producing glass lamination articles, the apparatus comprising:
a base supply unit comprising a plurality of convey rollers configured to transfer a base, and a plurality of centering bars each arranged between two adjacent ones of the plurality of convey rollers, the plurality of centering bars being configured to have an adjustable height;
a glass supply unit arranged at a vertical level higher than the base supply unit and configured to transfer a glass substrate layer; and
a laminate unit comprising a laminating roller configured to laminate the glass substrate layer on the base with an adhesive layer therebetween.

2. The apparatus of claim 1, wherein each of the plurality of centering bars is arranged between two adjacent ones of the plurality of convey rollers such that the base is aligned with a target position by each of the plurality of centering bars while the base is transferred by the plurality of convey rollers.

3. The apparatus of claim 1, wherein the plurality of centering bars are configured such that
when operating in a position adjustment mode, at least one of the plurality of centering bars moves upward to a vertical level higher than uppermost surfaces of the plurality of convey rollers to make contact with a bottom surface of the base, and
when operating in a transfer mode, the plurality of centering bars move downward to a vertical level lower than the uppermost surfaces of the plurality of convey rollers to depart from the bottom surface of the base and allow the uppermost surfaces of the plurality of convey rollers to make contact with the bottom surface of the base.

4. The apparatus of claim 1, wherein the plurality of convey rollers extend each in a first direction and are apart from each other in a second direction perpendicular to the first direction,
the plurality of centering bars extend each in the first direction and are apart from each other in the second direction perpendicular to the first direction, and
the plurality of centering bars and the plurality of convey rollers are alternately arranged in the second direction.

5. The apparatus of claim 1, wherein
the plurality of convey rollers extend each in a first direction and are apart from each other in a second direction perpendicular to the first direction,
the plurality of centering bars extend each in the first direction and are apart from each other in the second direction perpendicular to the first direction, and
the plurality of convey rollers and the plurality of centering bars are arranged in such a manner that two convey rollers and one centering bar are sequentially and repeatedly arranged in the second direction.

6. The apparatus of claim 1, wherein
the plurality of convey rollers comprise
a plurality of first edge convey rollers, a plurality of central convey rollers, and at least one second edge convey roller, and
the at least one second edge convey roller is adjacent to the laminate unit,
wherein each of the plurality of centering bars is arranged between two adjacent ones of the plurality of central convey rollers.

7. The apparatus of claim 1, wherein
the plurality of convey rollers comprise
a plurality of first edge convey rollers, a plurality of central convey rollers, and a plurality of second edge convey rollers, and
the plurality of second edge convey rollers are adjacent to the laminate unit,
wherein the plurality of centering bars are respectively arranged between two adjacent ones of the plurality of first edge convey rollers and between two adjacent ones of the plurality of second edge convey rollers.

8. The apparatus of claim 1, wherein
each of the plurality of centering bars comprises:
a base bar extending in a first direction and comprising a plurality of openings; and
convey balls arranged on the base bar in such a manner that lower portions of the convey balls are placed in the plurality of openings of the base bar, and upper portions of the convey balls are placed outside the plurality of openings of the base bar.

9. The apparatus of claim 1, wherein the plurality of convey rollers have a width of about 500 mm to about 2000 mm, and a distance between the plurality of covey rollers is from about 30 mm to about 300 mm.

10. The apparatus of claim 1, wherein
the plurality of convey rollers are polymeric roller, and
the plurality of convey rollers are connected to and driven by a timing belt.

11. The apparatus of claim 1,
wherein the glass supply unit comprises:
a glass feeding part arranged adjacent to the laminate unit at a vertical level higher than the plurality of convey rollers of the base supply unit; and
a gripper configured to fix an edge of the glass substrate layer for feeding the glass substrate layer into the laminate unit by using the glass feeding part.

12. The apparatus of claim 11, wherein the plurality of convey rollers, the laminating roller, and the glass feeding part are configured to be synchronized with each other and driven by a servo motor.

13. The apparatus of claim 11, wherein the gripper is configured such that while the glass substrate layer is moved a predetermined distance toward the laminate unit after the glass substrate layer is fed into the laminate unit, the gripper holds the glass substrate layer and moves together with the glass substrate layer toward the laminate unit in a moving direction of the glass substrate layer, and when the gripper arrives at a stop position, the gripper releases the glass substrate layer, wherein the stop position is apart from the laminate unit.

14. The apparatus of claim 11, wherein
the glass feeding part comprises a plurality of through-holes and is configured such that a bottom surface of the glass substrate layer is arranged on a top surface of the glass feeding part, and
the glass supply unit further comprises a gas spraying device configured to spray gas onto the bottom surface of the glass substrate layer through the plurality of through-holes.

15. The apparatus of claim 14, wherein the glass supply unit further comprises a guide member arranged on the glass feeding part and configured to stop the glass substrate layer by making contact with an edge of the glass substrate layer.

16. The apparatus of claim 15, wherein the laminating roller of the laminate unit comprises a first roller and a second roller, wherein the first and second rollers are arranged such that a bottom surface of the base comes into contact with the first roller, and a top surface of the glass substrate layer comes into contact with the second roller and
while the base and the glass substrate layer pass between the first and second rollers, the base and the glass substrate layer are attached to each other through the adhesive layer between the base and the glass substrate layer.

17. The apparatus of claim 16, wherein the laminating roller of the laminate unit further comprises a third roller arranged at a vertical level higher than the second roller and configured to make contact with the second roller and rotate in a direction opposite to a rotation direction of the second roller.

18. The apparatus of claim 16, further comprising an absorptive member supply unit configured to pass an absorptive member between the first and second rollers such that the absorptive member is between the second roller and the glass substrate layer.

19. The apparatus of claim 18, wherein the absorptive member is configured to absorb a portion of a material of the adhesive layer which leaks between edges of the base and the glass substrate layer when the base and the glass substrate layer pass through a gap between the first and second rollers and are attached to each other.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)
